(19) United States
(12) Patent Application Publication
(10) Pub. No.: US 2014/0023201 A1
(43) Pub. Date: Jan. 23, 2014

(54) Communication System and Method

(71) Applicant: Shavar Daniels, New York, NY (US)

(72) Inventor: Shavar Daniels, New York, NY (US)

(21) Appl. No.: 13/905,566

(22) Filed: May 30, 2013

Related U.S. Application Data
(60) Provisional application No. 61/673,271, filed on Jul. 19, 2012.

(51) Int. Cl. H04R 1/10

(52) U.S. Cl. CPC H04R 1/1091
USPC 381/74

(57) ABSTRACT

A communication system and method provides a communication device that fits on the ear and responds to audible commands. The communication system is sufficiently independent to initiate and receive communications without requiring a mobile phone, since contact information is stored in the communication device. The communication device is configured to receive a data cord for exchanging contact information with a processor. The communication system performs functions with an audible command, such as, initiating communication by speaking a contact name and/or number, accessing an encyclopedia, accessing an encyclopedia, accessing an internet, saving and filing text notes on a processor, accessing a positioning system, accessing a calculator, and accessing a radio. A power cord provides power from an external power source. The communication device is moisture resistant.

### CROSS-REFERENCE TO RELATED APPLICATIONS

The present Utility patent application claims priority benefit of the U.S. provisional application for patent Ser. No. 61/673,271, entitled “E-Phone”, filed on 19, Jul. 2012 under 35 U.S.C. 119(e). The contents of this related provisional application are incorporated herein by reference for all purposes to the extent that such subject matter is not inconsistent herewith or limiting hereof.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to communication systems and methods. More particularly, one or more embodiments of the invention relate to a wireless communication system that responds to audible commands.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a mobile phone is a device that can make and receive telephone calls over a radio link while moving around a wide geographic area. It does so by connecting to a cellular network provided by a mobile phone operator, allowing access to the public telephone network.

Typically, mobile phones are used for a variety of purposes, including keeping in touch with family members, conducting business, and having access to a telephone in the event of an emergency. Some people carry more than one cell phone for different purposes, such as for business and personal use.

Typically, Bluetooth is a wireless technology standard for exchanging data over short distances, using short-wavelength radio transmissions in the ISM band from 2400-2480 MHz, from fixed and mobile devices, creating personal area networks with high levels of security.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a detailed perspective of an exemplary communication system responding to an audible command, in accordance with an embodiment of the present invention;

FIG. 2 illustrates a top view of an exemplary communication device, an exemplary data cord, and an exemplary power cord, in accordance with an embodiment of the present invention;

FIGS. 3A and 3B illustrate top views of exemplary communication devices, in accordance with an embodiment of the present invention;

FIG. 4 illustrates a detailed perspective view of an exemplary communication device joined to an exemplary with an exemplary data cord, in accordance with an embodiment of the present invention;

FIG. 5 illustrates a flowchart diagram of an exemplary communication method, in accordance with an embodiment of the present invention; and

FIG. 6 illustrates a typical computer system that, when appropriately configured or designed, can serve as an exemplary method for identification, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of communication systems and methods that may be provided by preferred embodiments of the present invention. In one embodiment of the present invention, the communication system and method may provide a communication device configured to be operable to join with an ear and operable to respond to audible commands. The communication system may be sufficiently independent to initiate and receive communications without requiring a second communication device, since contact information is stored in the communication device. In one embodiment, the communication device may emit and receive short-wavelength radio transmissions and create a local network in proximity to the system. In some embodiments, the communication device may be configured to receive a data cord for exchanging data with a processor. The data may include, without limitation, contacts, files, positioning information, books, music, and radio entertainment. The data may be accessed, actuated, and transmitted with an audible command. In some embodiments, the communication system may perform at least one function with an audible command, including, without limitation, initiating communication by speaking a contact name and/or number, accessing an encyclopedia, accessing an internet, saving and filing text notes on a processor, accessing a positioning system, accessing a calculator, accessing a radio, etc.

In one embodiment of the present invention, the communication system may include a communication device configured to be operable to join with an ear and operable to respond to audible commands. The communication device may include, without limitation, a wireless phone that is worn on either left or right ear. The device may be operable to initiate communication with an audible command. The communication device may be moisture resistant and thereby operable outdoors while being worn on the ear. In some embodiments, the communication device may include a power switch for powering on and off the device. In some embodiments, the communication device may include a mounting portion for securing the communication device to the ear. The mounting portion may include a hook shape configured to at least partially wrap around the ear. In some embodiments, the communication device may include a microphone for receiving an audible command. The microphone may be operatively joined with a communication processor that positions inside the communication device. In some embodiments, a speaker portion may transmit communications form a different communication device.

In one embodiment of the present invention, the communication device may include a data port for receiving a data cord. The data cord may be configured to transmit data between the communication device and a processor. In some embodiments, the communication device may include a power port for receiving a power cord. The power cord may join with a power source for providing power to the communication device. In some embodiments, a display portion may provide a display of contacts, allow for initiating and receiving of communications. The display portion may include, without limitation, a touch screen.

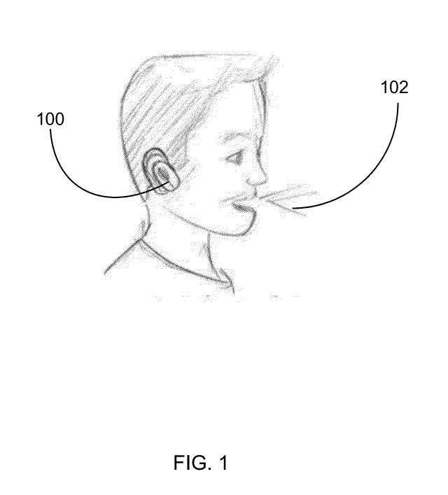

FIG. 1 illustrates a detailed perspective of an exemplary communication system responding to an audible command, in accordance with an embodiment of the present invention. In the present embodiment, a communication system and method may include a communication device 100 configured to be operable to join with an ear and operable to respond to an audible command 102. The communication system may be sufficiently independent to initiate and receive communications without requiring a second communication device, since contact information is stored in the communication device. In one embodiment, the communication device may emit and receive short-wavelength radio transmissions and create a local network in proximity to the system. In some embodiments, the communication device may be configured to receive a data cord for exchanging data with a processor. The data may include, without limitation, contacts, files, positioning information, books, music, and radio entertainment. The data may be accessed, actuated, and transmitted with an audible command. In some embodiments, the communication system may perform various functions with an audible command, including, without limitation, initiating communication by speaking a contact name and/or number, accessing an encyclopedia, accessing an internet, saving and filing text notes on a processor, accessing a positioning system, accessing a calculator, and accessing a radio.

In one embodiment of the present invention, the communication system may include a communication device configured to be operable to join with an ear and operable to respond to audible commands. The communication device may include, without limitation, a wireless phone that is worn on either left or right ear. The device may be operable to initiate communication with an audible command. The communication device may be moisture resistant and thereby operable outdoors while being worn on the ear.

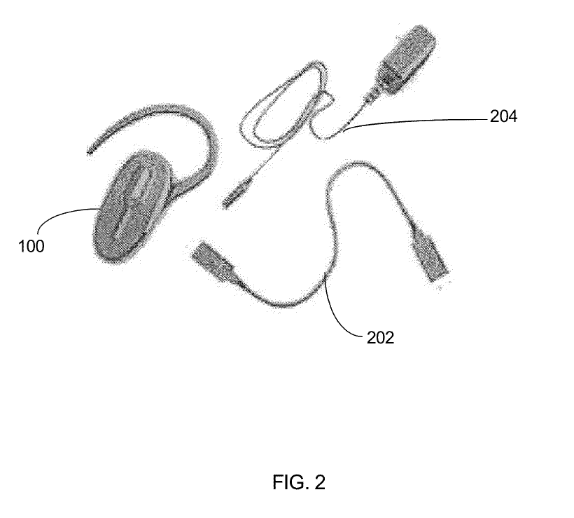

FIG. 2 illustrates a top view of an exemplary communication device, an exemplary data cord, and an exemplary power cord, in accordance with an embodiment of the present invention. In the present embodiment, the communication device may include a data port for receiving a data cord 202. The data cord may include, without limitation, a USB cord, an ethernet cable, a data cable, and a fiber optic cable. The data cord may be configured to transmit data between the communication device and a processor. The data may include a contact for communicating with. In this manner, the contact may be accessed from a database in the processor. However, in another embodiment, the communication device may exchange data with the processor remotely. In some embodiments, the communication device may include a power port for receiving a power cord 204. The power cord may join with a power source for providing power to the communication device. However, in another embodiment, the communication device may include a portable power source, including, without limitation, a battery, a solar cell, and a lithium polymer battery molded into the shape of an ear piece for efficient use of space and battery power.

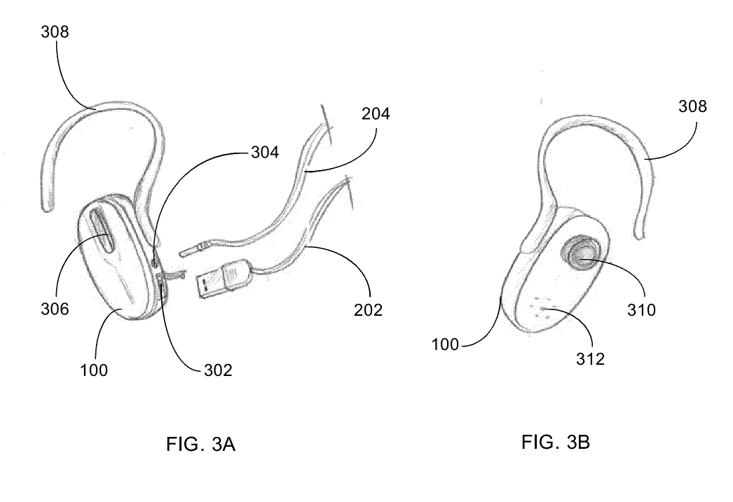

FIGS. 3A and 3B illustrate top views of exemplary communication devices, in accordance with an embodiment of the present invention. In the present embodiment, a data port 302 may position on the communication device for receiving the data cord. The data port may include, without limitation, a serial port, a terminal, a pin, and a pinout. In some embodiments, a power port 304 may receive the power cord from an external power source. In some embodiments, the communication device may include a power switch 306 for powering on and off the device. In some embodiments, the communication device may include a mounting portion 308 for securing the communication device to the ear. The mounting portion may include a hook shape configured to at least partially wrap around the ear. However, in other embodiments, the mounting portion may join the ear with other mechanisms, including, without limitation, an adhesive, a clip, a string, a hoop that completely wraps around the ear, etc. However, in other embodiments, the communication device may wedge inside the ear, without requiring a mounting portion. In some embodiments, the communication device may include a microphone 312 for receiving an audible command. The microphone may be operatively joined with a communication processor that positions inside the communication device. In some embodiments, a speaker portion 310 may transmit communications received form a different communication device. The speaker portion may include an adjustable volume operable with an audible command.

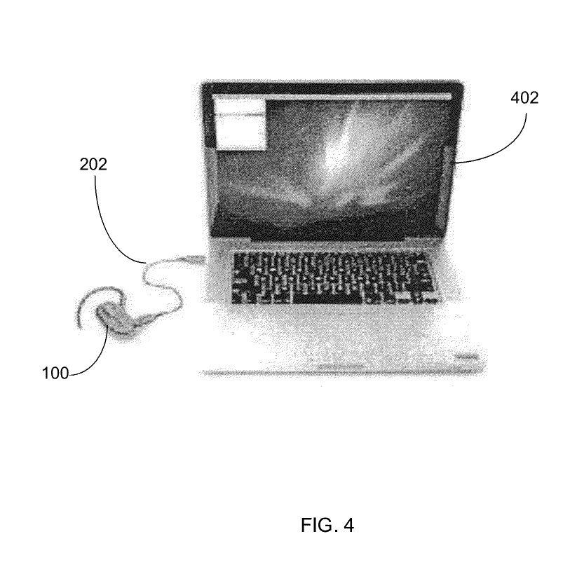

FIG. 4 illustrates a detailed perspective view of an exemplary communication device joined to an exemplary with an exemplary data cord, in accordance with an embodiment of the present invention. In the present embodiment, the communication device may include a data port for receiving a data cord. The data cord may be configured to transmit data between the communication device and a processor 402. The processor may include, without limitation, a computer, a database, a server, and an integrated circuit. In some embodiments, the communication device may include a power port for receiving a power cord. The power cord may join with a power source for providing power to the communication device. In some embodiments, a display portion may provide a display of contacts, allow for initiating and receiving of communications. The display portion may include, without limitation, a touch screen.

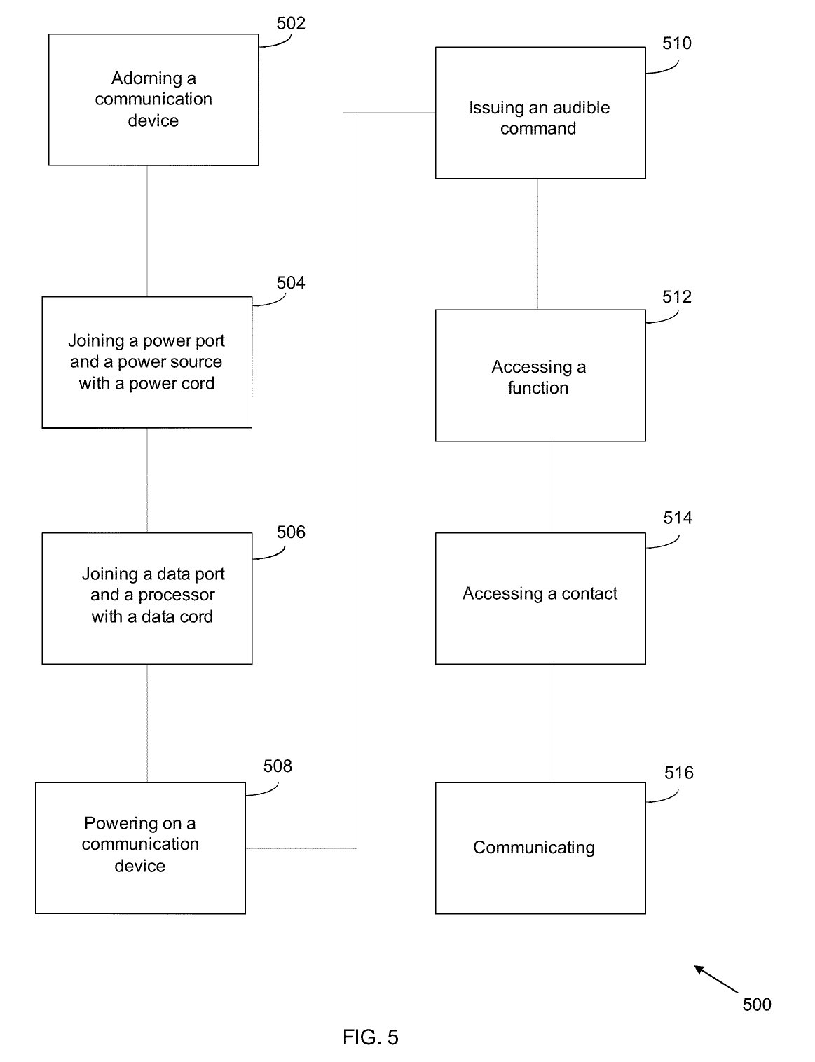

FIG. 5 illustrates a flowchart diagram of an exemplary communication method, in accordance with an embodiment of the present invention. In the present embodiment, a communication method 500 allows a user to initiate communications and access a plurality of functions with an audible command. A communication device is operable to access a contact and initiate communication with the contact upon an audible command. For example, without limitation, saying “Call Joe Davis” while wearing the communication device on the ear prompts the communication device to dial a specific phone number. The communication method also converts audible commands into functions, such as locating a spot with a positioning system, and accessing and using a dictionary. The communication method may utilize numerous steps to achieve the desired communication. A first Step 502 may include adorning a communication device. The communication device may include an ear piece with a mounting portion. The mounting portion may be configured to at least partially wrap around an ear. The communication device may be oriented so that an earpiece and a speaker face inwardly, towards an ear and a mouth. In this manner, audio signals from the communication are in proximity to the ear and mouth. A Step 504 may include joining a data port in the communication device to a processor with a data cord. The data cord may include, without limitation, a USB cable. However, in other embodiments, the data port may communicate with the processor wirelessly. The processor may include, without limitation, a computer, remote data storage, a server, and a network. In this manner, data, such as contact information may be shared between the communication device and the processor. A Step 506 may include joining a power port in the communication device to a power source with a power cord. However, in other embodiments, the communication device may include an internal power source.

In one embodiment of the present invention, a Step 508 may include powering on the communication device. A power switch and/or a touch screen may function to power on and power off the communication device. A Step 510 may include issuing an audible command to perform at least one function, including, without limitation, accessing a contact, initiating a communication, receiving a communication, accessing a positioning system, accessing an encyclopedia, and accessing a calculator. Those skilled in the art, in light of the present invention, will recognize that voice recognition software may be utilized to not only comprehend the audible command, but also to identify the speaker. A Step 512 may include accessing at least one function based on the audible command. The at least one function may include, without limitation, initiating communication by speaking a contact name and/or number, accessing an encyclopedia, accessing an encyclopedia, accessing an internet, saving and filing text notes on a processor, accessing a positioning system, accessing a calculator, and accessing a radio. A Step 514 may include accessing a contact for initiating a communication by giving an audible command. The contact may be stored on the processor, or on the communication device. A Step 516 may include communicating with the communication device. The communication system may be sufficiently independent to initiate and receive communications without requiring a second communication device, since contact information is stored in the communication device.

In one alternative embodiment, the communication device may include a scaled down cell phone implementation without power intensive multi-band capabilities, or processor intensive multi-media and internet. In yet another embodiment, the at least one function performed by the audible command can perform functions remotely, such as opening a garage door or powering off an electrical device. In yet another alternative embodiment, the contacts are received wirelessly rather than with a data cord.

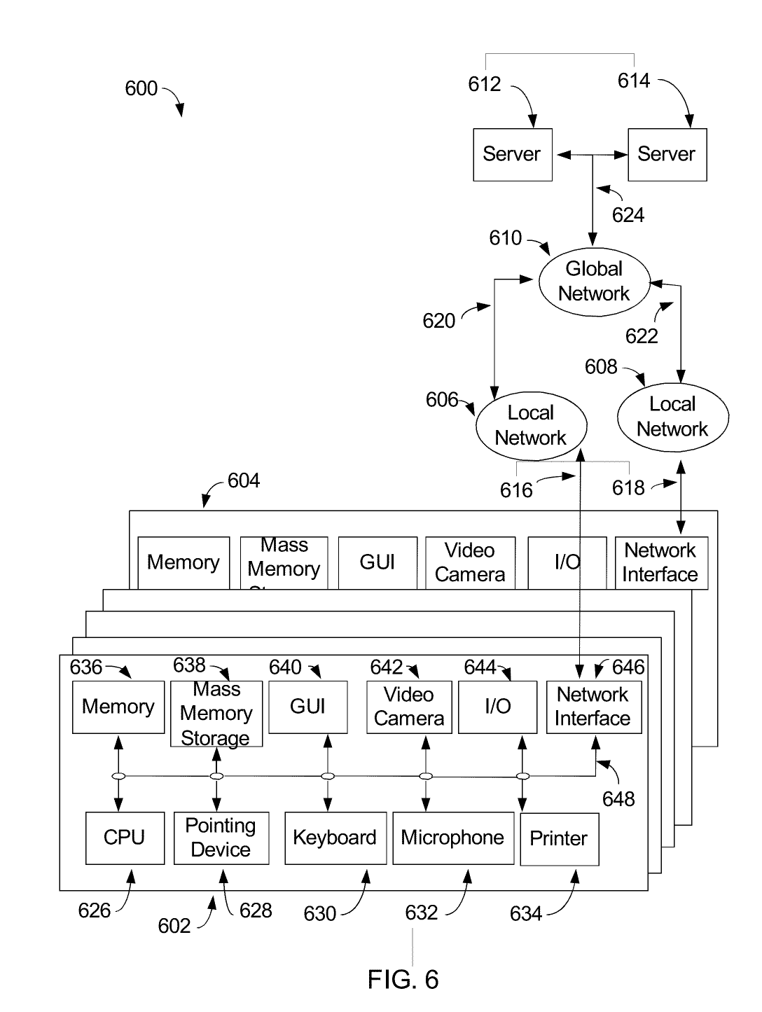

FIG. 6 illustrates a typical computer system that, when appropriately configured or designed, can serve as an exemplary method for identification, in accordance with an embodiment of the present invention. In the present invention, a communication system 600 includes a multiplicity of clients with a sampling of clients denoted as a client 602 and a client 604, a multiplicity of local networks with a sampling of networks denoted as a local network 606 and a local network 608, a global network 610 and a multiplicity of servers with a sampling of servers denoted as a server 612 and a server 616.

Client 602 may communicate bi-directionally with local network 606 via a communication channel 616. Client 604 may communicate bi-directionally with local network 608 via a communication channel 618. Local network 606 may communicate bi-directionally with global network 610 via a communication channel 620. Local network 608 may communicate bi-directionally with global network 610 via a communication channel 622. Global network 610 may communicate bi-directionally with server 612 and server 616 via a communication channel 624. Server 612 and server 616 may communicate bi-directionally with each other via communication channel 624. Furthermore, clients 602, 604, local networks 606, 608, global network 610 and servers 612, 616 may each communicate bi-directionally with each other.

In one embodiment, global network 610 may operate as the Internet. It will be understood by those skilled in the art that communication system 600 may take many different forms. Non-limiting examples of forms for communication system 600 include local area networks (LANs), wide area networks (WANs), wired telephone networks, wireless networks, or any other network supporting data communication between respective entities.

Clients 602 and 604 may take many different forms. Non-limiting examples of clients 602 and 604 include personal computers, personal digital assistants (PDAs), cellular phones and smartphones.

Client 602 includes a CPU 626, a pointing device 628, a keyboard 630, a microphone 632, a printer 634, a memory 636, a mass memory storage 638, a GUI 660, a video camera 662, an input/output interface 664 and a network interface 666.

CPU 626, pointing device 628, keyboard 630, microphone 632, printer 634, memory 636, mass memory storage 638, GUI 660, video camera 662, input/output interface 664 and network interface 666 may communicate in a unidirectional manner or a bi-directional manner with each other via a communication channel 668. Communication channel 668 may be configured as a single communication channel or a multiplicity of communication channels.

CPU 626 may be comprised of a single processor or multiple processors. CPU 626 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 636 is used typically to transfer data and instructions to CPU 626 in a bi-directional manner. Memory 636, as discussed previously, may include any suitable computer-readable media, intended for data storage, such as those described above excluding any wired or wireless transmissions unless specifically noted. Mass memory storage 638 may also be coupled bi-directionally to CPU 626 and provides additional data storage capacity and may include any of the computer-readable media described above. Mass memory storage 638 may be used to store programs, data and the like and is typically a secondary storage medium such as a hard disk. It will be appreciated that the information retained within mass memory storage 638, may, in appropriate cases, be incorporated in standard fashion as part of memory 636 as virtual memory.

CPU 626 may be coupled to GUI 660. GUI 660 enables a user to view the operation of computer operating system and software. CPU 626 may be coupled to pointing device 628. Non-limiting examples of pointing device 628 include computer mouse, trackball and touchpad. Pointing device 628 enables a user with the capability to maneuver a computer cursor about the viewing area of GUI 660 and select areas or features in the viewing area of GUI 660. CPU 626 may be coupled to keyboard 630. Keyboard 630 enables a user with the capability to input alphanumeric textual information to CPU 626. CPU 626 may be coupled to microphone 632. Microphone 632 enables audio produced by a user to be recorded, processed and communicated by CPU 626. CPU 626 may be connected to printer 636. Printer 636 enables a user with the capability to print information to a sheet of paper. CPU 626 may be connected to video camera 662. Video camera 662 enables video produced or captured by user to be recorded, processed and communicated by CPU 626.

CPU 626 may also be coupled to input/output interface 664 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 626 optionally may be coupled to network interface 666 which enables communication with an external device such as a database or a computer or telecommunications or internet network using an external connection shown generally as communication channel 616, which may be implemented as a hardwired or wireless communications link using suitable conventional technologies. With such a connection, CPU 626 might receive information from the network, or might output information to a network in the course of performing the method steps described in the teachings of the present invention.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing an ear piece that receives and sends communications and provides functions with audible commands according to the present invention will be apparent to those skilled in the art. Various aspects of the invention have been described above by way of illustration, and the specific embodiments disclosed are not intended to limit the invention to the particular forms disclosed. The particular implementation of the ear piece that receives and sends communications and provides functions with audible commands may vary depending upon the particular context or application. By way of example, and not limitation, the ear piece that receives and sends communications and provides functions with audible commands described in the foregoing were principally directed to a voice commanded cellular phone worn around the ear implementations; however, similar techniques may instead be applied to walkie talkie devices that can download GPS tracking, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
a communication device, said communication device being configured to be operable to at least partially join an ear, said communication device being operable to initiate a communication with an audible command, said communication device further being operable to perform at least one function with an audible command, said communication device further being configured to exchange data with an external processor.

2. The system of claim 1, in which said communication device comprises an ear piece.

3. The system of claim 2, wherein said earpiece is configured to join with a left ear or a right ear.

4. The system of claim 1, in which said communication device comprises a mounting portion, said mounting portion comprising a hook shape, said mounting portion being configured to at least partially wrap around an ear for joining said communication device with said ear.

5. The system of claim 1, in which said communication device comprises a data port, said data port being configured to exchange data with said external processor.

6. The system of claim 5, wherein a data cord joins said data port with said external processor.

7. The system of claim 6, wherein said data cord comprises a USB cord.

8. The system of claim 7, in which said data comprises a contact.

9. The system of claim 8, in which said external processor comprises a computer.

10. The system of claim 9, in which said initiating a communication with an audible command comprises speaking a name of said contact.

11. The system of claim 1, in which said communication device comprises a power cord, said power cord being configured to join a power port with an external power source for receiving power.

12. The system of claim 1, in which said communication device comprises a power port, said power port being configured to receive power from an external power source.

13. The system of claim 12, wherein a power cord joins said power port with said external power source.

14. The system of claim 1, in which said communication device comprises a microphone, said microphone being configured to receive said audible command.

15. The system of claim 1, in which said communication device comprises a speaker portion, said speaker portion being configured to emit an audio signal.

16. The system of claim 15, wherein said speaker is operable to announce a name and/or a number for received communications.

17. The system of claim 1, in which said communication device comprises a touch screen display.

18. The system of claim 1, in which said communication device comprises a power switch, said power switch being configured to power on and power off said communication device.

19. A system comprising:
means for adorning a communication device;
means for joining a data port and an external processor with a data cord;
means for joining a power port and a power source with a power cord;
means for powering on said communication device;
means for issuing an audible command;
means for accessing at least one function;
means for accessing a contact; and
means for communicating.

20. A system consisting of:
a communication device, said communication device comprising an ear piece, said communication device being configured to be operable to at least partially join an ear, said communication device being operable to initiate a communication with an audible command, said communication device further being operable to perform at least one function with an audible command, said communication device further being configured to exchange data with an external processor, said communication device further comprising a mounting portion, said mounting portion comprising a hook shape, said mounting portion being configured to at least partially wrap around an ear for joining said communication device with said ear, said communication device comprising a data port, said data port being configured to exchange data with said external processor, said communication device further comprising a power port, said power port being configured to receive power from an external power source, said communication device further comprising a microphone, said microphone being configured to receive said audible command, said communication device further comprising a speaker portion, said speaker portion being configured to emit an audio signal, said communication device comprising a power switch, said power switch being configured to power on and power off said communication device.
